(19) United States
(12) Patent Application Publication
(10) Pub. No.: US 2026/0312374 A1
(43) Pub. Date: Oct. 8, 2026

(54) DC COMBINER BOX

(71) Applicant: DS2.0, LLC, Portland, TN (US)

(72) Inventors: Dean Solon, Gallatin, TN (US); Anthony Lee Morgan, Westmoreland, TN (US); Dorothy Lou Michael, Greenbrier, TN (US)

(21) Appl. No.: 19/710,232

(22) Filed: Jun. 16, 2026

Related U.S. Application Data
(63) Continuation of application No. 19/308,728, filed on Aug. 25, 2025.
Application No. 19/308,728 is a continuation-in-part of application No. 19/233,496, filed on Jun. 10, 2025.
Application No. 19/233,496 is a continuation-in-part of application No. 19/044,907, filed on Feb. 4, 2025.
(60) Provisional application No. 63/733,943, filed on Dec. 13, 2024.

(51) Int. Cl. H02B 1/18; H02B 1/04; H02B 1/20; H02B 1/48

(52) U.S. Cl. CPC H02B 1/18; H02B 1/04; H02B 1/20; H02B 1/48

(57) ABSTRACT

This disclosure describes a DC combiner box that has improved field installation capabilities and has decoupled thermal load between input fuses. The DC combiner box can be a junction box that includes a backplate; an input bus mounted to the backplate; an output bus mounted to the backplate; a crimp connector mounted to the backplate and electrically connected to the output bus, wherein the crimp connector includes a viewing window located proximate to an end of a barrel section of the crimp connector, thereby providing visibility of a stripped wire that is fully inserted through the barrel section; and a housing at least partially enclosing the output bus and the crimp connector.

### CLAIM OF PRIORITY

This application is a Continuation of U.S. Application No. 19/308,728, filed on Aug 25, 2025, which is a Continuation-in-Part of U.S. Patent Application No. 19/233,496, filed on Jun 10, 2025, which is a Continuation-in-Part of U.S. Patent Application No. 19/044,907, filed on Feb 4, 2025, which claims priority to U.S. Provisional Application No. 63/733,943, filed on Dec 13, 2024. The disclosures of the prior applications are considered part of and are incorporated by reference in the disclosure of this application.

### BACKGROUND

Solar arrays made up of multiple photovoltaic panels (“panels”) are often installed in strings. Many panels in the arrays are often wired together to form a single DC output or groups of DC outputs that are of a useful power level. Combining each DC output during panel installation can be a time-consuming process which requires mating of numerous, potentially high voltage or high current connections. Damage to components can also occur during installation.

### SUMMARY

The present disclosure involves methods, systems, and an apparatus for a DC combiner box that has improved field installation capabilities and has decoupled thermal load between input fuses. The DC combiner box can be a junction box that includes a backplate; an input bus mounted to the backplate; an output bus mounted to the backplate; a crimp connector mounted to the backplate and electrically connected to the output bus; and a housing at least partially enclosing the output bus and the crimp connector.

Implementations can optionally include one or more of the following features.

In some instances, the output bus and the input bus are electrically connected by a switch.

In some instances, implementations include a plurality of protective devices connected to the input bus, wherein each of the plurality of protective devices is configured to receive a connection from an external source.

In some instances, the plurality of protective devices are positioned in two or more rows, and wherein each row is offset from adjacent rows in two dimensions.

In some instances, the plurality of protective devices comprise fuse holders.

In some instances, the crimp connector is mounted to the backplate in a position aligned with a feed hole in the housing.

In some instances, there is an unobstructed path between the feed hole and the crimp connector.

Implementations can further include a junction box that includes: a backplate; an input bus mounted to the backplate; an output bus mounted to the backplate; a plurality of protective devices connected to the input bus, wherein each of the plurality of protective devices is configured to receive a connection from an external source; and a housing at least partially enclosing the plurality of protective devices.

In some instances, the plurality of protective devices are positioned in two or more rows, and wherein each row is offset from adjacent rows in two dimensions.

In some instances, the plurality of protective devices comprise fuse holders.

In some instances, implementations include a crimp connector mounted to the backplate and electrically connected to the output bus.

In some instances, the crimp connector is mounted to the backplate in a position aligned with a feed hole in the housing.

In some instances, there is an unobstructed path between the feed hole and the crimp connector.

In some instances, the output bus and the input bus are electrically connected by a switch.

The present disclosure further describes a method including: mounting a junction box to a fixed surface; inserting two or more input wires into the junction box and connecting the input wires to an input bus; inserting one or more output wires into the junction box and into one or more pre-installed crimp connectors; and crimping the pre-installed crimp connectors onto the output wires.

In some instances, the input wires are each connected to the input bus through a protective device.

In some instances, each protective device comprises a fuse holder, and wherein each protective device has space between it and adjacent protective devices.

In some instances, the method includes inserting the one or more output wires into the junction box and into the one or more pre-installed crimp connectors comprises inserting the one or more output wires into feed holes that are aligned with the pre-installed crimp connectors.

In some instances, the method includes closing a switch, wherein the switch is configured to connect the input bus to the pre-installed crimp connectors.

In some instances, the input wires are each connected to a solar panel.

Implementations can further include a junction box that includes: a backplate; an input bus mounted to the backplate; an output bus mounted to the backplate; a crimp connector mounted to the backplate and electrically connected to the output bus, wherein the crimp connector includes a viewing window located proximate to an end of a barrel section of the crimp connector, thereby providing visibility of a stripped wire that is fully inserted through the barrel section; and a housing at least partially enclosing the output bus and the crimp connector.

In some instances, the output bus and the input bus are electrically connected by a switch.

In some instances, a plurality of protective devices are connected to the input bus, where each of the plurality of protective devices is configured to receive a connection from an external source. In some instances, the plurality of protective devices are positioned in two or more rows, and wherein each row is offset from adjacent rows in two dimensions. The plurality of protective devices can be fuse holders.

In some instances, the crimp connector is mounted to the backplate in a position aligned with a feed hole in the housing.

The subject matter discussed herein can provide one or more of the following advantages. For example, the configuration of the DC combiner box discussed herein can facilitate faster installation, for example, by using a pre-installed crimp connectors that are configured to receive the large gauge (e.g., 750 MCM) cables that are used as output cables to carry the combined DC power of a solar array. The configuration of the DC combiner box discussed herein can also reduce damage to components that can occur during installation. For example, installation of a conventional DC combiner box requires the large gauge output cables to be bent or otherwise flexed to make electrical connections. This bending of the large gauge cables puts stress on the cable itself, which can deteriorate the integrity of the large cables, which are not intended to be bent at the angles required for installation in a conventional DC combiner box. Using the pre-installed crimp connectors of the present DC combiner box eliminates the need to bend the large output cable. Rather, the large output cable can simply be inserted straight into the crimp connecter, and secured by applying adequate pressure to the crimp connector. The bending of the large output cable also puts unintended pressure on the structure of conventional DC combiner boxes, which can lead to cracking of the conventional DC combiner box at the point of entry of the large output cable. The inclusion of the pre-installed crimp connector in the present DC combiner box, the large output cable does not have to be bent during installation, thereby eliminating the stress/pressure that is put on the DC combiner box at the point of entry of the large output cable, which prevents the cracking experienced when installing conventional DC combiner boxes. Furthermore, as discussed in more detail below, the offset arrangement of fuse holders of the present DC combiner box reduces thermal coupling between rows of fuses, thereby reducing the frequency of failures related to overheating that is experienced using conventional DC combiner boxes, which do not utilize the present offset arrangement of fuse holders.

The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 depicts an example system with a solar array using a DC combiner box.

FIG. 2 illustrates a perspective view of an example DC combiner box.

FIG. 3 illustrates a perspective view of some internals of an example DC combiner box.

FIG. 4 illustrates a front view of some internals of an example DC combiner box.

FIG. 5 illustrates a front view of an example DC combiner box with some wires installed.

FIG. 6 is a side perspective view of some internals of an example DC combiner box.

FIG. 7 is a perspective view of a pre-installed crimp connector and bus bar in a DC combiner box.

FIG. 8 illustrates a front view of some internals of an example DC combiner box.

FIGS. 9A and 9B illustrate a cutaway diagram of a permanent fastener used to make an electrical connection.

FIGS. 10A and 10B illustrate a cutaway diagram of a permanent shear fastener used to make an electrical connection.

FIGS. 11A-11D illustrate a crimp lug that includes a viewing window.

FIGS. 12A-12C are illustrations of a crimp lug that includes a viewing window.

### DETAILED DESCRIPTION

This disclosure describes implementations for a direct current (DC) combiner box or junction box that has improved field installation capabilities and has decoupled thermal load between input fuses. Solar arrays (e.g., arrays of photovoltaic (PV) panels), or other DC sources often have their outputs combined to achieve a more useful current capacity. For example, each panel in a string of solar panels (e.g., 20 panel, 50 panels, 200 panels, etc.) can have its relatively low amperage DC output connected or combined with the DC output of the other panels or sources to provide a single, high amperage output. This combination can be done in a junction box, with many, relatively low current input wires and few (e.g., 2) relatively high current output wires. When installing or connecting a solar array, this junction box or combination box is conventionally connected in the field by an installation technician. Because it is desirable for the combiner box to be located physically near the panel array, the connection is often made in adverse conditions such as exposed to harsh weather environments (e.g., rain, snow, heat, cold, etc.) or physically difficult locations (e.g., rooftops, attics, small spaces, near other equipment, etc.). Therefore, it is advantageous to have a DC combiner box that is easily installed requiring less time and space for the installation technician to operate.

Additionally, some or all the wires feeding into or out of the combiner box will use overcurrent protection such as breakers or fuses. Because the DC combiner box is often exposed to the weather, or must transmit large DC power, heat removal and mitigation is desirable. Conventional DC combiner boxes often include fuse holders or breakers that are densely packed in rows. A weakness of this configuration is that as physically lower fuses or breakers generate heat (e.g., during normal or high current states), that heat is convectively transferred to fuses (or breakers) above them and can be conducted to adjacent protective devices. Therefore, protective devices in higher rows are heated both by their own operation (e.g., internal resistance) and by adjacent or lower protective devices through convection or conduction. This extra heating can cause fuses or breakers in higher positions within the DC combiner box to be more likely to fail even when they are not in an overcurrent condition.

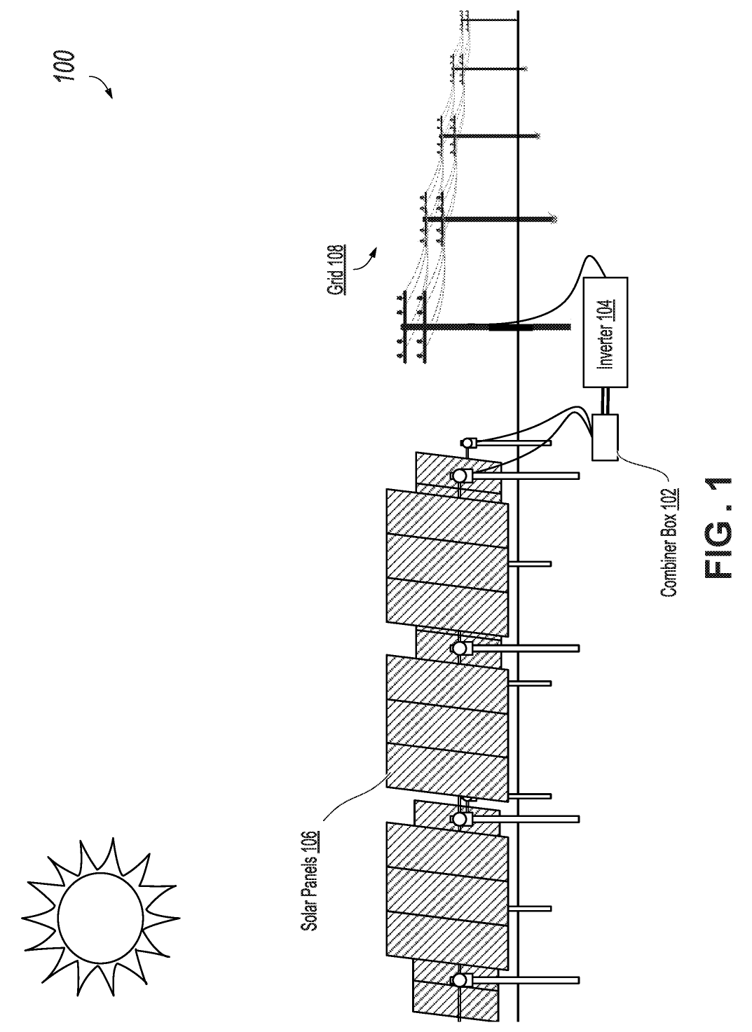

Turning to FIG. 1, FIG. 1 depicts an example system 100 with a solar array using a DC combiner box. In the illustrated system 100, the combiner box 102 is supplied from an array of solar panels 106. While two strings are illustrated, more or fewer strings is possible. The combiner box 102 combines several outputs (e.g., 2, 4, 12, 24, etc.) from the solar panels 106 into a single DC output that is provided to the inverter 104. The inverter 104 converts the DC output of the combiner box 102 into alternating current (AC) power, which in the illustrated example, is supplied to the grid 108.

In some implementations, instead of an inverter 104 and/or grid 108, other applications are possible. For example, the solar panels 106 can be connected to a combiner box 102 which supplies a battery, DC motor, home or building inverter, or other components (not shown).

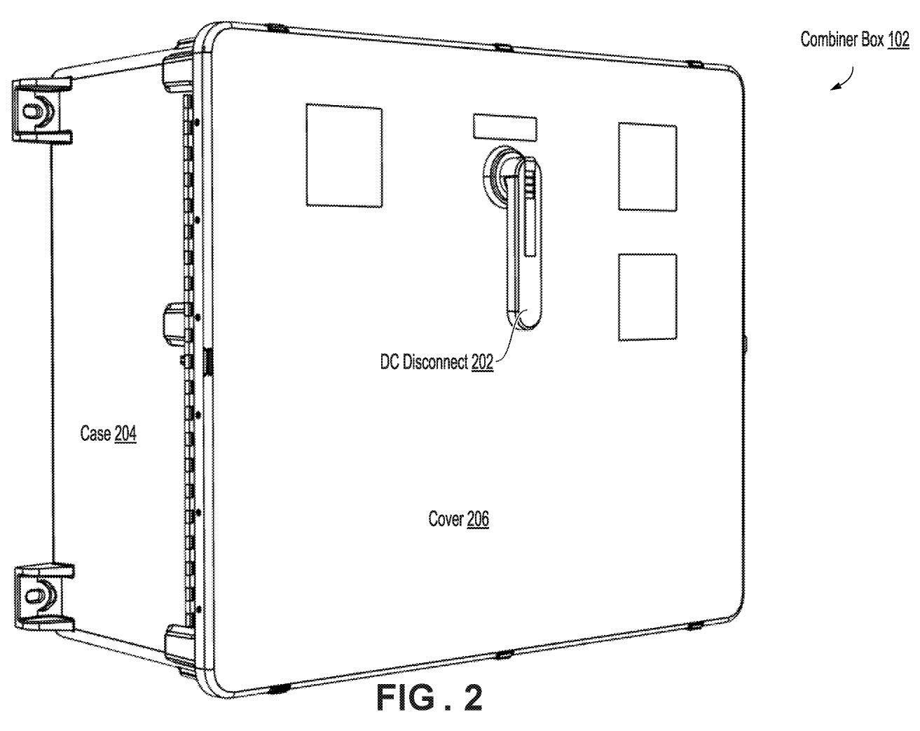

FIG. 2 illustrates a perspective view of an example DC combiner box 102. The DC combiner box 102 can be a wall mounted box as illustrated in FIG. 2, or floor mounted. It can have a polycarbonate, steel, aluminum, or other case 204 that generally encloses and shelters the electronic components within. A cover 206 can be removably connected to the case 204, for example using a hinge, and can provide a seal for the enclosure when shut. In some implementations, a DC disconnect 202 is provided within the DC combiner box 102. As illustrated, the DC disconnect 202 can include a handle, which can be rotated to either connect or disconnect the multiple DC inputs with the single (or fewer) DC outputs.

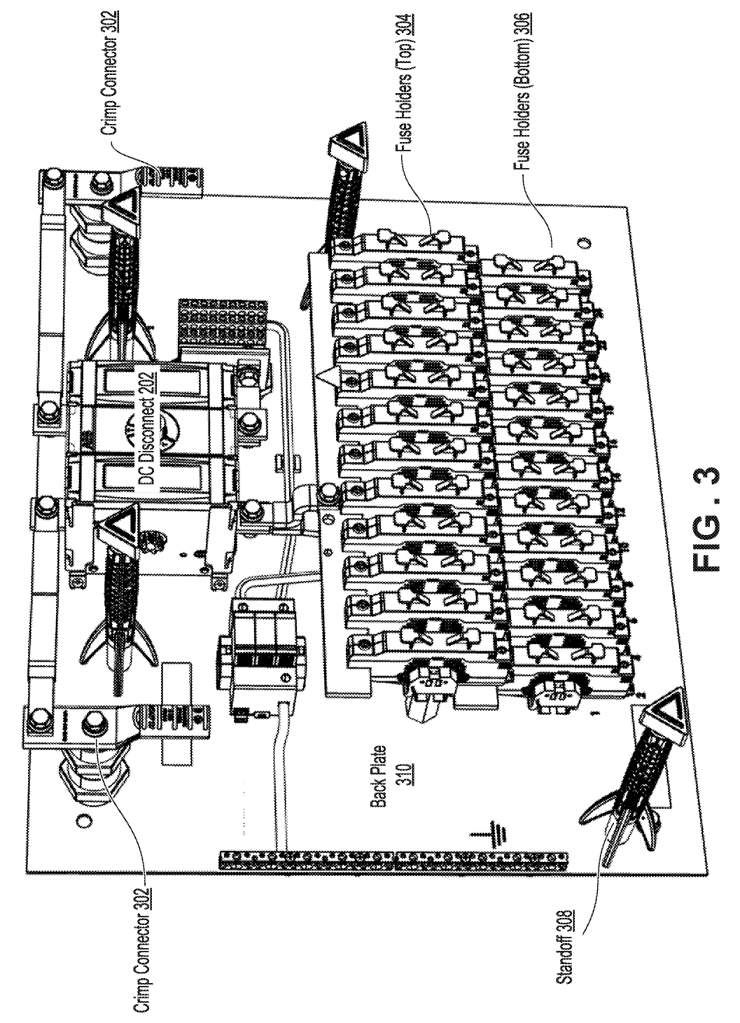

FIG. 3 illustrates a perspective view of some internals of an example DC combiner box. It should be noted that certain structural components, and wiring has been removed for clarity. The internal components can include one or more crimp connectors 302, two separate sets of fuse holders 304, 306, and one or more stand offs 308, mounted to a backplate 310. In some implementations, different connectors are possible. For example, a screw-type or spring-type terminal block connecter, heat shrink connector, spade/slot connector, etc.

In some implementations, the backplate 310 is a part of the case 204. In some implementations, the backplate 310 is a separate component mounted to the case 204 and can be electrically isolated from the case 204.

The standoffs 308, four in the illustrated example, can be insulative structural components that provide an indexing and mounting point for a cover plate (not shown) which can act as a safety barrier to reduce the risk of inadvertent contact with live electronics. Additionally, the standoffs 308 can provide rigidity to the cover 206 when it is shut. In some implementations, the standoffs can be formed in the shape of a rocket.

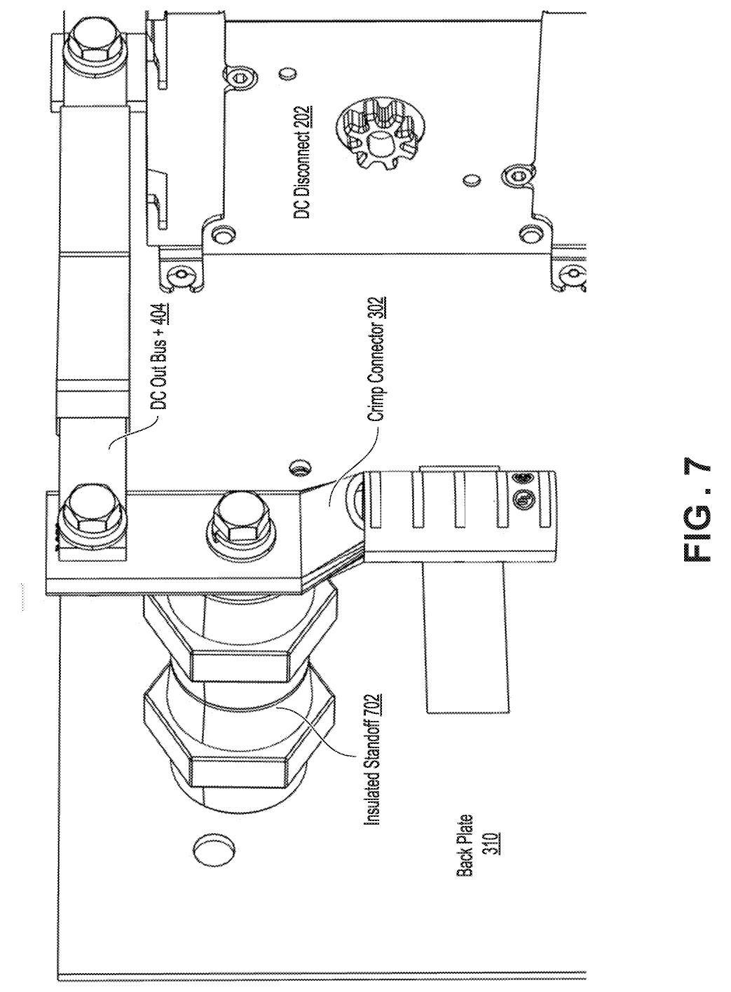

The crimp connectors 302 provide for making a connection with the output of DC disconnect 202 to wires. The crimp connectors are discussed in greater detail below with regard to FIG. 7.

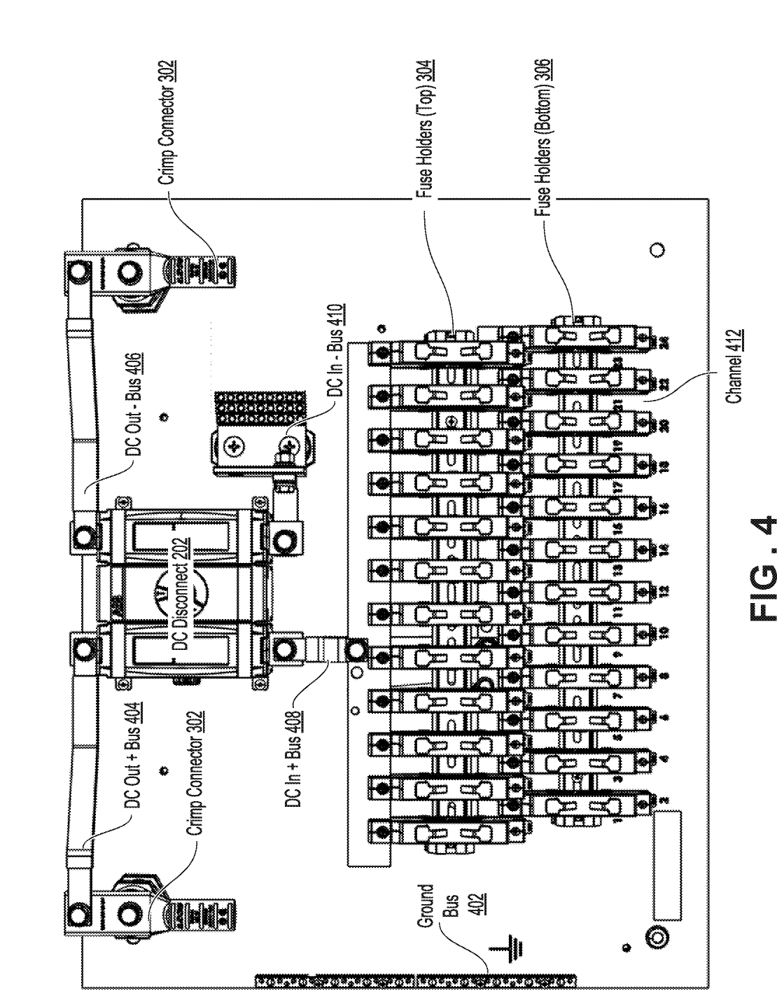

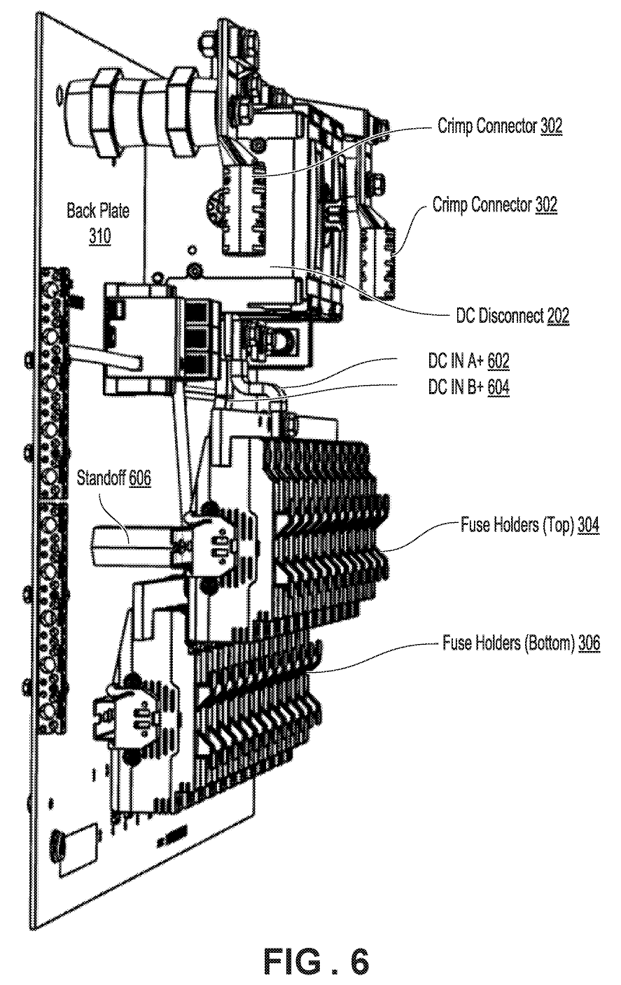

The fuse holders 304 and 306 are positioned to reduce thermal communication, in order to increase the expected life of installed fuses. For example, each row includes spaces between the holders, as well as is staggered with respect to the adjacent rows. It should be noted that while fuse holders are illustrated, other protective devices such as circuit breakers, surge protection devices, relays, inrush current limiters, or other devices are possible. The fuse holders 304 and 306 are described in more detail below with respect to FIG. 4 and 6.

FIG. 4 illustrates a front view of some internals of an example DC combiner box. In general, DC power flows from multiple sources through the bottom of fuse holders 304 and 306, where it is combined in the DC busses 408 and 410. Power flows from the DC busses 408 and 410, through the DC disconnect 202 and into the DC out busses 404 and 406. Additionally a ground bus 402 can be provided for ensuring internal structural components, sensors, or other systems do not develop a significant potential with respect to ground.

As shown in FIG. 4, the fuse bottom fuse holders 306 are laterally offset from the top fuse holders 304. Further, a gap exists between each individual fuse holder, such that no fuse holder is directly above or directly adjacent to any other fuse holder. In other words, the lateral spacing between the bottom fuse holders 306 defines channels between the bottom fuse holders 306. For example, channel 412. These channels allow for airflow between the bottom fuse holders 306. Furthermore, the top fuse holders 304 are laterally installed at locations that are aligned with (e.g., above) the channels defined by the bottom fuse holders 306. In operation, heat from the bottom fuse holders 306 will rise, and pass through channels defined by the top fuse holders 304, thereby bypassing the top fuse holders 304. This configuration allows heat from fuses in the bottom fuse holders 306 to rise away from the fuses without directly heating fuses in the top fuse holders 304. Additionally, by stacking the top fuse holders 304 in a separate row (as opposed to having a single row of fuse holders) space can be left between each fuse holder, to minimize conduction of heat laterally. In addition to laterally offsetting the top fuse holders 304 from the bottom fuse holders 306 (and vice versa), as discussed above, the top fuse holders 304 can be offset horizontally (e.g., away from the back plate 310) to further decouple heat transfer between fuses installed in the fuse holders, as discussed in more detail with reference to FIG. 6.

Each fuse holder is connected to the DC In positive bus 408, which is in turn connected to the DC disconnect 202. A DC in negative bus 410 provided, such that a technician can install a positive and a negative wire from each panel to be connected. The illustrated example supports up to twenty-four separate sources. It should be noted that, while no fuse holders are illustrated for the DC negative bus 410, it is possible to include additional rows or columns of fuse holders or other protective devices for a fully protected configuration.

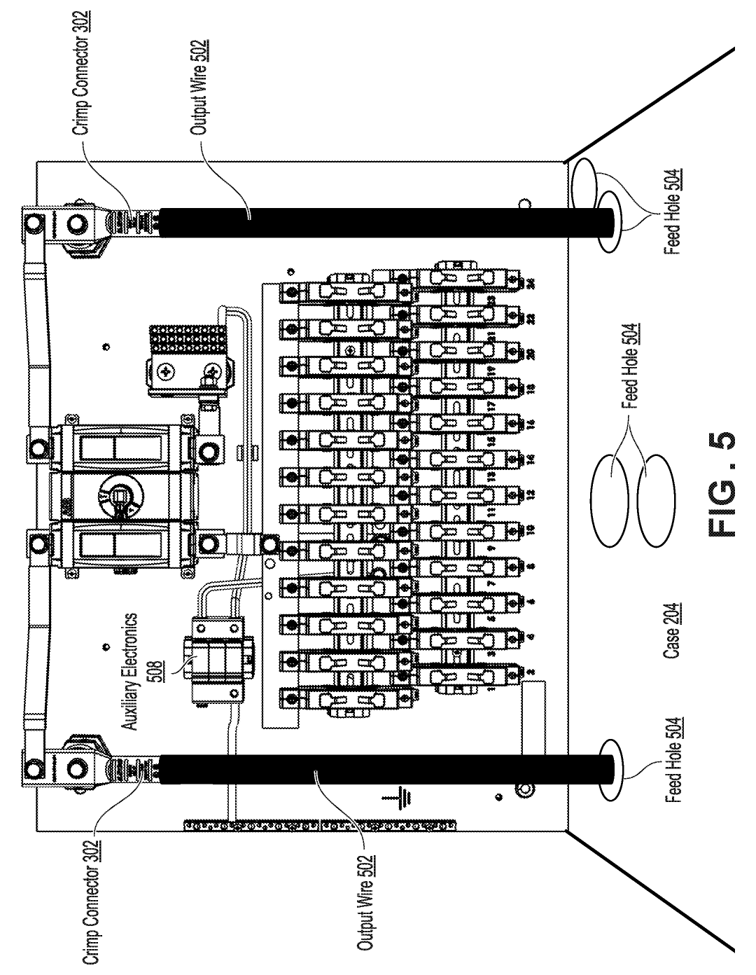

The DC out positive 404 and DC out negative 406 busses can be connected at the time of manufacture of the DC combiner box and connected to crimp connectors 302. The crimp connectors 302 can each be aligned with a feed hole as described below with respect FIG. 5. In some implementations, the bus bars (e.g., DC out positive 404 and DC out negative 406, as well as other bus bars described in this disclosure) can be braided bus bars. Braided bus bars can be formed of a flexible braid of conductive material such as copper or aluminum. To create a mounting point, or a rigid portion of the bus bar, that portion can be ultrasonically welded. Ultrasonic welding can use high-frequency vibrations to create a solid-state weld between materials generating heat at the interface of the materials. This can cause the braided conductor to melt and form a strong bond and useful mounting point. Ultrasonic welding is useful for its speed, precision, and energy efficiency. In some implementations, other techniques are used. For example, in some implementations, the bus bars are solid conductor that is machined to a specific shape. In some implementations, there can be a combination of braided and unbraided bus bars.

FIG. 5 illustrates a front view of an example DC combiner box with some wires/cables installed. Specifically, the output wires 502 have been fed through feed holes 504 in the bottom of the cover 206 and mated with their respective crimp connectors 302. Output wires 502 can be 600 thousandths of circular mils (MCM), 750 MCM, 800 MCM, or greater size wires. These wires can be stranded or solid, copper or aluminum, or other wire. In general, because they tend to be relatively thick, bending the wires to install crimp connectors or bolt the wire to a bus can be a high effort, time consuming endeavor. Particularly where there are adverse external conditions such as limited space, inclement weather, or limited time to install. By pre-installing crimp connectors directly over associated feed holes 504, the output wires 502 can be threaded straight into the combiner box and crimped in position without the need to make time consuming, high effort bends in the wires. It should be noted that while two output wires 502 are illustrated. In some implementations, a single output wire is used. For example, where the negative bus is connected to ground, a single “hot” wire can be used.

In the illustrated example, additional feed holes 504 are provided to allow for the input wires from solar panels (not shown) both positive, and negative. In some implementations, these feed holes 504 are cut or drilled in the field. In these implementations, a mark can be provided on the case to show externally where a feed hole 504 will align with a crimp connector or the fuse holders. By aligning/forming the feed holes 504 at locations below the crimp connectors, the output wires 502 can be directly inserted into the feed holes and fed directly into the crimp connectors without having to bend the output wires more than a threshold amount. In this way, the stress placed on the output wires 502 and/or the perimeter of the feed holes 504 can be reduced/eliminated, thereby reducing the damage that often occurs when installing a conventional DC combiner box as previously discussed (e.g., deterioration of the integrity of the cables and/or damage to the DC combiner box (e.g., cracking) due to the stress placed on the perimeter of the feed holes 504).

Also illustrated in FIG. 5 is an auxiliary electronics pack 508. Auxiliary electronics 508 can be, for example, a surge protector, temperature, voltage, or current sensor, or other component. In the illustrated example, the auxiliary electronics pack 508 is connected across the combined input and has a connection to ground. In some implementations, other electronics can be installed within the DC combiner box, such as communication systems (e.g., Wi-Fi or radio cards) sensors, other protective devices, switches, controllers, or others.

FIG. 6 is a side perspective view of some internals of an example DC combiner box. FIG. 6 illustrates how the top fuse holders 304 are horizontally offset from the bottom fuse holders 306 (e.g., in a direction away from the backplate 310) by being mounted to the backplate 310 using a standoff 606. This provides additional separation between the bottom fuse holders 306 and the top fuse holders 304, further reducing thermal communication between fuses. For example, the horizontal offset configuration of the top fuse holders 304 relative to the bottom fuse holders 306 provides yet another channel through which air, and therefore heat generated by fuses installed in the bottom fuse holders 306, can pass. This reduces the amount of heat transferred from fuses installed in the bottom fuse holders 306 to fuses installed in the top fuse holders 304, which reduces the likelihood of failure due to thermal coupling between the rows of fuses.

In the illustrated example, the positive DC bus input is split, with DC in A 602 being connected to the top fuse holders 304, and DC in B 604 connected to the bottom fuse holders 306, while both DC inputs 602 and 604 are connected at the DC disconnect 202.

FIG. 7 is a perspective view of a pre-installed crimp connector 302 and DC output bus 404 in a DC combiner box. The crimp connector 302 is mounted on an insulated standoff 702, which prevents or minimizes current leakage to the case backplate 310 other components of the DC combiner box. The length of the DC output bus bar 404, and the position of the insulated standoff 702, can be selected to position the crimp connector 302 over a feed hole or feed hole location in the combiner box.

In order to connect the output wires (e.g., output wires 502 of FIG. 5) a technician need only insert the wire through the feed hole and pass it straight up into the crimp connector 302. The crimp connector 302 can be a mechanical device used to join two or more electrical conductors by deforming the metal conductors around a metal sleeve or terminal. This can be performed using a tool such as a crimper. The process involves inserting the stripped ends of the conductors into the crimp connector 302, then squeezing the connector with the tool or crimper. This action compresses the metal sleeve or terminal, forming a tight, mechanically secure connection that also provides electrical conductivity.

It should be noted that, while the features in this disclosure have been described in the context of a DC combiner box, with multiple inputs and a single output. The opposite is possible, where a single input is distributed to many outputs (DC distributer box). Additionally, the pre-installed crimp connectors aligned with feed holes can be useful in a junction box that has a single input and single output (DC or AC disconnect box). The present disclosure is not limited to any particular number of inputs and outputs.

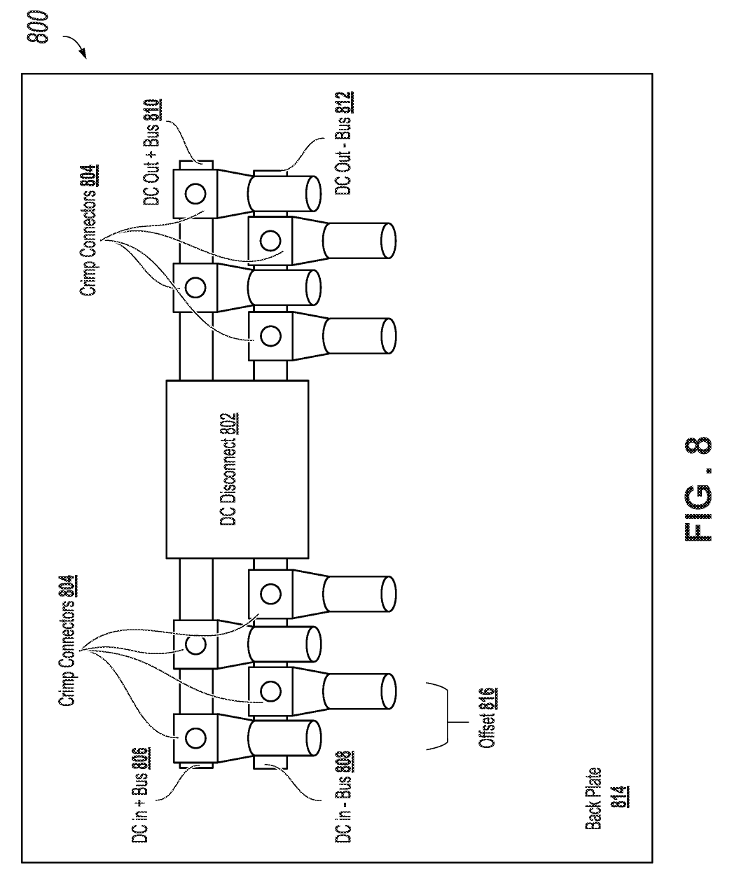

FIG. 8 illustrates a front view of some internals of an example DC combiner box. The example combiner box 800 has two parallel DC inputs and two parallel DC outputs. Each input and output includes a pre-installed crimp connector 804, that can be used to establish and electrical connection to their respective buses (806-812) through the DC disconnect 802.

Each bus 804-812 includes two mounting points that enable connection of the crimp connector directly to the bus bar instead of through a “landing pad” as is conventionally used. The elimination of landing pads in the connectors significantly reduces the number of standoffs required, the number of connections made, and therefore contact resistance between components (e.g., from crimp to landing pad, and landing pad to bus bar). Further, this reduces the time and effort required to install, particularly where the mounting points are aligned with feed holes as shown and describe above (see, e.g., FIG. 5). Additionally, by connecting a portion of the input or output toward the center of the bus, the ohmic losses and heating is reduced, as not all current flows the entire length of the bus bar.

In some implementations, the mounting points on the negative bus bars (808, 812) and the positive bus bars (806, 810) are horizontally offset 816. This enables access to the higher bus bar without interference between connectors.

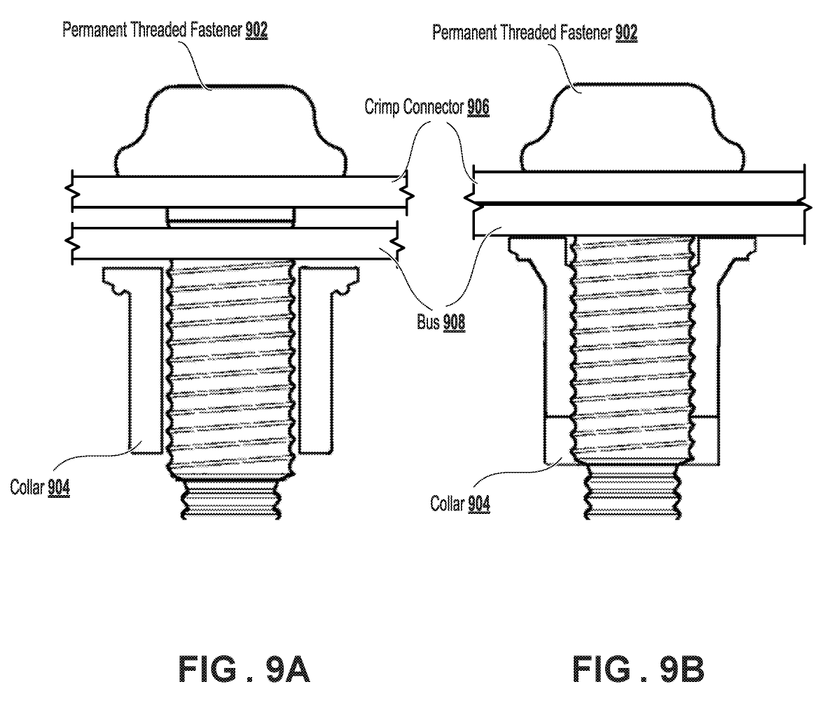

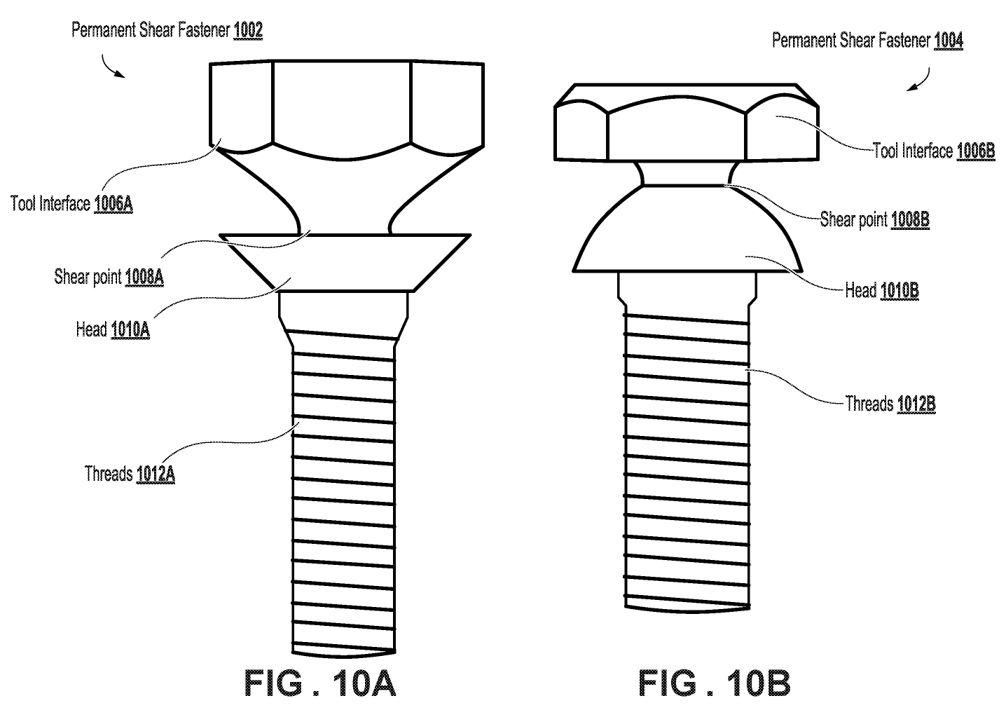

Crimp connectors 804 are illustrated with a single connection point. In this implementation, a single fastener can be used to mate the crimp connector and bus bar, as well as establish a mechanical connection to backplate 814, for example using a standoff (not shown). In some implementations, crimp connectors with two mounting points can be used as shown above (see, e.g., FIG. 7). In some implementations, the crimp connectors 804 are bolted to their respective bus bars. In some implementations, a more permanent connection is used such as riveting, welding, soldering, etc. Any suitable mechanical and electrical connection can be used. For example, permanent swaged fasteners as described below with respect to FIGS. 9A and 9B can be used to affix the crimp connectors 804 to the busses (806-812). In another example, permanent shear fasteners as described below with respect to FIGS. 10A and 10B can be used to affix the crimp connectors 804 to the busses (806-812).

FIGS. 9A and 9B illustrate a cutaway diagram of a permanent fastener used to make an electrical connection. In FIG. 9A, the permanent swaged fastener 902 is installed but not yet affixed, and in FIG. 9B the permanent swaged fastener has been affixed. The permanent swaged fastener 902 can form a mechanical and an electrical connection between the crimp connector 906 and the bus 908.

In general, the permanent swaged fastener 902 is inserted into a hole through the crimp connector 906 and bus 908. A collar 904 is placed over the fastener 902 (FIG. 9A) and then swaged onto the threads of the permanent swaged fastener 902. This creates a mechanical connection that, unlike a nut and bolt, does not permit relative motion between the collar 904 and the fastener 902. Therefore, the permanent swaged fastener 902 is resistant to loosening over time because of vibration, temperature cycles, or other factors. Use of these fasteners to connect the crimp connectors 906 to the bus 908 reduces the required maintenance, and therefore increases the safety and up-time of the associated junction box.

The clamp force of the permanent swaged fastener 902 is a function of the materials used, swaging technique, and threads. These can be configured to ensure a consistent and reliable mechanical connection across multiple material types. This can also provide an electrical connection between the bus 908 and the crimp connector 906. For example, a clamp force that compresses the crimp connector 906 and bus 908 to within 20% of their respective plastic deformation threshold will ensure a solid mechanical connection without creating undue ohmic losses because of deformation within the metal.

FIGS. 10A and 10B illustrate a cutaway diagram of permanent shear fasteners configured to make an electrical connection. These fasteners can be used to connect the crimp connectors and bus bars previously discussed, or fasten bus bars to structural components (e.g., an insulated standoff as described above with respect to FIG. 7). Permanent fasteners as described in FIGS. 10A and 10B, and FIGS. 9A and 9B are advantageous in that they can provide secure connections without requirements for additional maintenance (e.g., re-torquing, inspecting, or other maintenance).

Each of the example permanent shear fasteners 1002 and 1004 are shear bolts, with a tool interface 1006A or 1006B configured to enable the use of a tool (e.g., hex wrench, Allen key, screwdriver, torque wrench, etc.) to engage with the bolt and thread it, using threads 1012A or 1012B into a mating thread (e.g., positioned in the bus bar or the insulated standoff upon which the fastener is to be installed). A shear point (1008A or 1008B) can be designed to shear the tool interface (1006A or 1006B) from the head (1010A or 1010B) at a predetermined torque, leaving a smooth surface that permanently engages the fastener. For example, the shear points 1008A and 1008B can be manufactured having a reduced diameter (e.g., relative to other diameters of the fasteners 1002 and 1004) that will fail at the predetermined torque. This reduced diameter can be designed as a notch, groove, or undercut to create a weaker area that defines a predetermined point of failure. The smaller the cross-sectional area (e.g., diameter) of the shear point (1008A or 1008B), the lower the torque required to break the fastener cleanly. Generally, the shear strength of the shear point (1008A or 1008B) is proportional to the cross-sectional area of the shear point and the material’s shear strength.

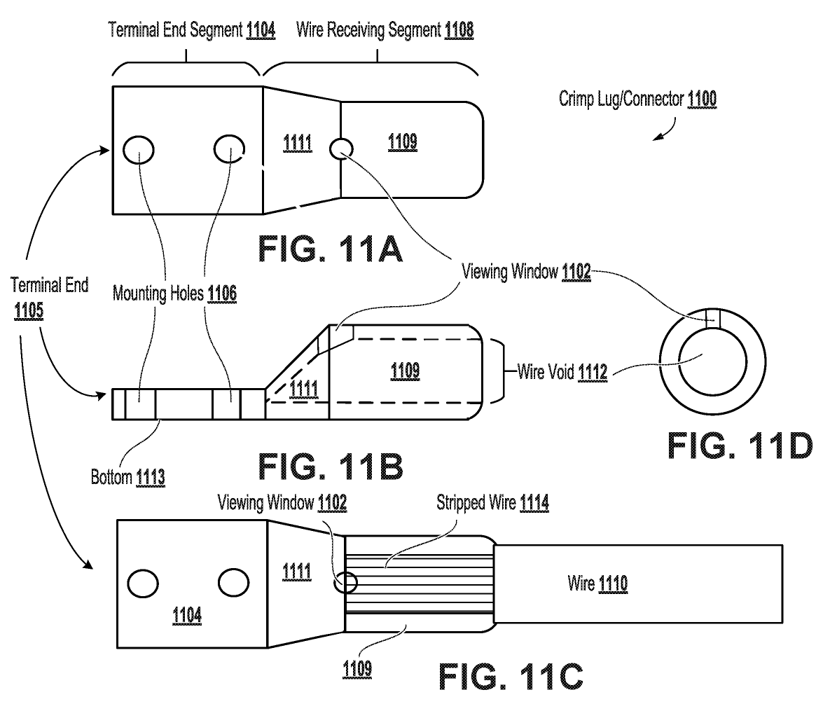

FIGS. 11A-11D illustrate a crimp lug 1100 (also referred to as a crimp connector) that includes a viewing window 1102. FIG. 11A is a top view of the crimp lug 1100. FIG. 11B is a side view of the crimp lug 1100. FIG. 11C is another top view of the crimp lug 1100 with a wire 1110 inserted into the crimp lug 1100. FIG. 11D is front view looking into the wire receiving segment 1108.

The crimp lug 1100 includes a terminal end segment 1104 that ends at the terminal end 1105 of the crimp lug 1100, and is configured to be attached to the DC Bus Bar previously discussed, a terminal block, or another electrical connection point. In the shown configuration, the terminal end segment 1104 includes two mounting holes 1106 that extend through a thickness of the terminal end segment 1104, as shown by the dotted lines in FIG. 11B. The mounting holes 1106 are configured to receive fasteners, such as those discussed above with reference to FIGS. 10A and 10B. The mounting holes 1106 can be formed, for example, in a center 1/3 of the width of the terminal end segment 1104. The terminal end segment 1104 is considered to extend from the terminal end 1105 to the start of the tapered section 111, which is the point at which the height of the crimp lug 1100 (e.g., distance from the bottom 1113) begins to increase beyond normal manufacturing tolerances. The terminal end segment 1104 can be made of any appropriate conductor material.

The crimp lug 1100 also includes a wire receiving segment 1108, which include a barrel section 1109 and a tapered section 1111. The wire receiving segment 1108 is configured to receive a wire to be electrically connected to another component (e.g., the DC Bus Bar) by way of the terminal end 1104. The wire receiving segment 1108 can have a wire void 1112 defined therein. The wire void 1112 can be cylindrical, and the diameter of the wire void 1112 can be selected to be proportional to the gauge of wire that is intended to be inserted into the wire receiving segment 1108. The wire receiving segment 1108 is configured to be deformable so that the wire 1110 inserted into the wire receiving segment 1108 can be secured to the crimp lug 1100, for example, by using a crimping tool. The size of the wire receiving segment 1108 tapers (e.g., diminishes) in the direction of the terminal end 1105 and the junction between the wire receiving segment 1108 and the terminal end segment 1104. For example, as shown, an angled reduction in size of the wire receiving segment (and the internal wire void 1112) occurs in the direction of the terminal end segment 1104.

The crimp lug 1100 also includes the viewing window 1102. The viewing window 1102 can be a hole (void) that is formed in the wire receiving segment 1108. In some implementations, as shown, the viewing window 1102 can be formed at a location where the size of the wire receiving segment begins to taper. As shown, approximately ½ of the viewing window 1102 is located inside the tapered section 1111, and approximately ½ of the viewing window is located over the barrel section 1109. For example, the viewing window 1102 can be centered on an axis that bisects (or otherwise goes through) an apex of a curve or angle formed by the exterior of the barrel section 1109 and the tapered section 1111 (e.g., the top lines on the side view of FIG. 11B). In some implementations, the viewing window 1102 can be formed in other locations, such as having more, or all of the viewing window 1102 formed in the barrel section 1109, or having more or all of the viewing window 1102 located in the tapered section 1111.

The function of the viewing window 1102 is to allow installers to ensure that the stripped wire 1114 is fully inserted to the end of the barrel section 1109 before crimping the stripped wire 1114 inside the crimp lug 1100. This prevents situations in which a poor electrical connection is made because of a poor connection between the crimp lug 1100 and the stripped wire 1114. The size of the viewing window 1102 can be selected, for example, to prevent the stripped wire 1114 from extending outside of the wire receiving segment 1108, while still enabling the installer to visualize the stripped wire 1114 inside the wire receiving segment 1108.

The tapered section 1111 is formed in between the wire receiving segment 1108 and the terminal end segment 1104. The tapered section 1111 has a void defined therein, but the size of the void diminishes as it extends from the wire receiving segment 1108 towards the terminal end segment 1104.

In some implementations, the crimp lug 1100 can be used as the pre-installed crimp connector 302 previously discussed.

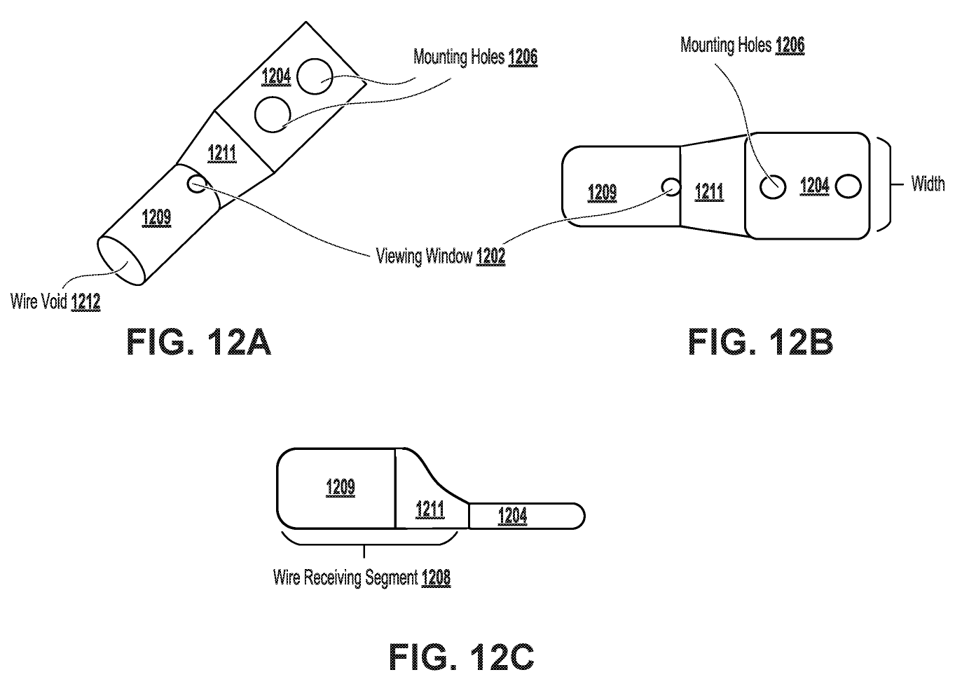

FIGS. 12A-12C are illustrations of a crimp lug 1200 that includes a viewing window 1202. The crimp lug 1200 includes a terminal end segment 1204 similar to the terminal end segment 1104 of the crimp lug 1100, and is configured to be attached to the DC Bus Bar previously discussed, a terminal block, or another electrical connection point. In the shown configuration, the terminal end segment 1204 includes two mounting holes 1206 that extend through a thickness of the terminal end segment 1204, as shown. The mounting holes 1206 are configured to receive fasteners, such as those discussed above with reference to FIGS. 10A and 10B. The mounting holes 1206 can be formed, for example, in a center 1/3 of the width of the terminal end segment 1204. The terminal end segment 1204 can be made of any appropriate conductor material.

The crimp lug 1200 also includes a wire receiving segment 1208, which include a barrel section 1209 and the tapered section 1211. The wire receiving segment 1208 is configured to receive a wire that is to be electrically connected to another component (e.g., the DC Bus Bar) by way of the terminal end segment 1204. The wire receiving segment 1208 can have a wire void 1212 defined therein. The wire void 1212 can be cylindrical (or another appropriate shape depending on the wire to be inserted), and the diameter of the wire void 1212 can be selected to be proportional to the gauge of wire that is intended to be inserted into the wire receiving segment 1208. The wire receiving segment 1208 is configured to be deformable so that a wire inserted into the wire receiving segment 1208 can be secured to the crimp lug 1200, for example, by using a crimping tool. The size of the wire receiving segment 1208 tapers (e.g., diminishes) in the direction of the terminal end segment 1204 and the junction between the wire receiving segment 1208 and the terminal end segment 1204. For example, as shown, an angled reduction in size of the wire receiving segment 1208 (and the internal wire void 1212) occurs in the direction of the terminal end segment 1204.

The crimp lug 1200 also includes the viewing window 1202. The viewing window 1202 can be a hole (void) that is formed in the wire receiving segment 1208. In some implementations, as shown, the viewing window 1202 can be formed proximate to a location where the size of the wire receiving segment 1208 begins to taper. As shown, most of the viewing window 1202 is located within the barrel section 1209, with an edge of the viewing window 1202 being formed in the tapered section 1211. The location of the viewing window 1202 can be adjusted depending on the application. For example, the viewing window 1202 can be centered on an axis that bisects (or otherwise goes through) an apex of a curve or angle formed by the exterior of the barrel section 1209 and the tapered section 1211. Alternatively, the viewing window 1202 can be formed so that the axis that bisects (or otherwise goes through) an apex of a curve or angle formed by the exterior of the barrel section 1209 and the tapered section 1211 is tangential to the edge of the viewing window 1202. In some implementations, the viewing window 1202 can be formed in other locations, such as having more, or all of the viewing window 1202 formed in the barrel section 1209, or having more or all of the viewing window 1202 located in the tapered section 1211.

The function of the viewing window 1202 is to allow installers to ensure that a stripped wire is fully inserted to the end of the barrel section 1209 before crimping the stripped wire 1214 inside the crimp lug 1200. This prevents situations in which a poor electrical connection is made because of a poor connection between the crimp lug 1200 and the stripped wire. The size of the viewing window 1202 can be selected, for example, to prevent the stripped wire from extending outside of the wire receiving segment 1208, while still enabling the installer to visualize the stripped wire inside the wire receiving segment 1208.

The tapered section 1211 is formed in between the wire receiving segment 1208 and the terminal end segment 1204. The tapered section 1211 has a void defined therein, but the size of the void diminishes as it extends from the wire receiving segment 1208 towards the terminal end segment 1204.

In some implementations, the crimp lug 1200 can be used as the pre-installed crimp connector 302 previously discussed.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

The foregoing description is provided in the context of one or more particular implementations. Various modifications, alterations, and permutations of the disclosed implementations can be made without departing from scope of the disclosure. Thus, the present disclosure is not intended to be limited only to the described or illustrated implementations but is to be accorded the widest scope consistent with the principles and features disclosed herein.

What is claimed is:

1. A crimp lug for terminating an electrical conductor, the crimp lug comprising:
a conductive body including:
a terminal end segment extending to a terminal end, the terminal end segment configured for electrical connection to a bus bar; and
a wire receiving segment comprising:
a barrel section defining a wire void configured to receive the electrical conductor;
a transition zone connecting the barrel section to the terminal end segment, wherein an outer dimension of the conductive body decreases within the transition zone toward the terminal end segment; and
a viewing window formed through a wall of the wire receiving segment and opening into an interior of the wire receiving segment, wherein the viewing window is positioned at least partially within the barrel section.

2. The crimp lug of claim 1, wherein the viewing window is positioned at least partially within the transition zone such that the viewing window spans a boundary between the barrel section and the transition zone.

3. The crimp lug of claim 2, wherein approximately half of the viewing window is located within the transition zone and approximately half of the viewing window is located within the barrel section.

4. The crimp lug of claim 3, wherein the boundary between the barrel section and the transition zone is defined by a curve or angle formed on an exterior surface of the wire receiving segment, and wherein the viewing window is centered on an axis that bisects an apex of the curve or angle.

5. The crimp lug of claim 2, wherein a majority of the viewing window is located within the barrel section, and wherein an edge of the viewing window is located within the transition zone.

6. The crimp lug of claim 4, wherein the boundary between the barrel section and the transition zone is defined by a curve or angle formed on an exterior surface of the wire receiving segment, and wherein an axis that goes through an apex of the curve or angle is tangential to an edge of the viewing window.

7. The crimp lug of claim 1, wherein the viewing window is located entirely within the barrel section.

8. The crimp lug of claim 7, wherein an edge of the viewing window is adjacent to a boundary between the barrel section and the transition zone.

9. The crimp lug of claim 1, wherein the transition zone connecting the barrel section and the terminal end segment is a tapered section defined by a curve or angle formed on an exterior surface of the wire receiving segment.

10. The crimp lug of claim 9, and the viewing window is substantially centered on an axis that bisects an apex of the curve or angle.

11. The crimp lug of claim 9, wherein a majority of the viewing window is located within the barrel section, and an edge of the viewing window is formed within the tapered section.

12. The crimp lug of claim 9, wherein an axis that goes through an apex of the curve or angle is tangential to an edge of the viewing window.

13. The crimp lug of claim 1, wherein the terminal end segment comprises a flat tongue having a width, and wherein the flat tongue includes a pair of mounting holes extending through a thickness of the flat tongue.

14. The crimp lug of claim 13, wherein the pair of mounting holes are aligned along a longitudinal axis of the flat tongue and are formed within a center one-third of the width of the flat tongue.

15. The crimp lug of claim 1, wherein the wire receiving segment is formed of a deformable conductive material configured to deform around the electrical conductor under mechanical pressure.

16. The crimp lug of claim 1, wherein the wire void of the barrel section is cylindrical and has a diameter proportioned to receive a stranded conductor having a wire gauge of 600 MCM or greater.
